(19) United States
(12) Patent Application Publication
(10) Pub. No.: US 2025/0346154 A1
(43) Pub. Date: Nov. 13, 2025

(54) ELECTRIFIED VEHICLE

(71) Applicant: TOYOTA JIDOSHA KABUSHIKI KAISHA, Tokyota-shi (JP)

(72) Inventor: Tatsuaki SUZUKI, Numazu-shi (JP)

(73) Assignee: TOYOTA JIDOSHA KABUSHIKI KAISHA, Tokyota-shi (JP)

(21) Appl. No.: 19/013,438

(22) Filed: Jan. 8, 2025

(30) Foreign Application Priority Data
May 10, 2024 (JP) 2024-077440

(51) Int. Cl. B60L 58/26; B60H 1/00; B60H 1/14; B60L 50/60; H01M 10/613; H01M 10/625; H01M 10/635; H01M 10/663; H01M 50/249

(52) U.S. Cl. CPC B60L 58/26; B60L 50/66; H01M 10/613; H01M 10/625; H01M 10/635; H01M 10/663; H01M 50/249; B60H 1/00278; B60H 1/143; H01M 2220/20

(57) ABSTRACT

Electrified vehicle includes a battery unit, a cooling system that cools the battery unit according to the instructed target battery temperature, an air conditioner that controls the temperature in the vehicle cabin, and a control device that can selectively execute the plurality of driving modes. The plurality of traveling modes includes a normal traveling mode and a high-load traveling mode in which a traveling load is higher than that in a case where the normal traveling mode is executed. In a state in which heating in the vehicle cabin is required, the control device (a) instructs the cooling system to set a first target temperature as a target battery temperature when the high-load running mode is executed, and (b) instructs the cooling system to set a second target temperature higher than the first target temperature as a target battery temperature when the normal running mode is executed.

### CROSS-REFERENCE TO RELATED APPLICATION

This application claims priority to Japanese Patent Application No. 2024-077440 filed on May 10, 2024, incorporated herein by reference in its entirety.

### BACKGROUND

### 1. Technical Field

The technology disclosed herein relates to an electrified vehicle.

### 2. Description of Related Art

Japanese Patent No. 3114366 (JP 3114366 B) discloses an electrified vehicle including a battery unit, a cooling system for cooling the battery unit, an air conditioner, and a control device. The control device drives the cooling system so that the temperature of the battery unit follows a target battery temperature.

### SUMMARY

In the electrified vehicle of JP 3114366 B, the vehicle cabin is heated by utilizing exhaust heat of the battery unit. The present specification provides a novel and useful technology capable of effectively utilizing exhaust heat of a battery unit while suppressing acceleration of deterioration of the battery unit.

In a first aspect disclosed herein, an electrified vehicle may include:
a battery unit;
a cooling system configured to cool the battery unit based on a target battery temperature under instruction;
an air conditioner configured to control a temperature in a vehicle cabin; and
a control device configured to selectively execute a plurality of traveling modes including a normal traveling mode and a high load traveling mode expected to perform traveling with a traveling load higher than a traveling load in the normal traveling mode.

### The Control Device may be Configured to:

when the high load traveling mode is executed in a state in which heating in the vehicle cabin is requested, give an instruction to the cooling system for a first target temperature as the target battery temperature; and
when the normal traveling mode is executed in the state in which the heating in the vehicle cabin is requested, give an instruction to the cooling system for a second target temperature higher than the first target temperature as the target battery temperature.

In general, the maximum cooling capacity of the cooling system (hereinafter referred to as “maximum cooling capacity”) is designed based on the heat generation amount of the electrified vehicle to be cooled by the cooling system. In the above electrified vehicle, the maximum cooling capacity is designed based on the maximum heat generation amount in the high load traveling mode.

In general, in the electrified vehicle, the temperature of the battery unit (hereinafter referred to as “battery temperature”) is controlled by the cooling system so as not to be higher than a temperature at which deterioration of the battery unit is likely to proceed (hereinafter referred to as “threshold temperature”).

In the above configuration, when the normal traveling mode is executed in the state in which the heating in the vehicle cabin is requested, the control device gives the instruction to the cooling system for the second target temperature as the target battery temperature. Since the maximum cooling capacity is designed based on the maximum heat generation amount in the high load traveling mode, there is a sufficient margin between the maximum heat generation amount in the normal traveling mode and the maximum cooling capacity. Therefore, even when the instruction is given for the second target temperature as the target battery temperature, it is possible to reduce the occurrence of a case where the battery temperature is higher than the threshold temperature. With the instruction for the second target temperature as the target battery temperature, the vehicle cabin is easily warmed by the exhaust heat of the battery unit. Therefore, it is possible to effectively utilize the exhaust heat of the battery unit while suppressing the acceleration of the deterioration of the battery unit.

In a second aspect, in the first aspect, the control device may be configured to:
when the normal traveling mode is executed in a state in which the heating in the vehicle cabin is requested and a battery cooling capacity available for cooling the battery unit in a cooling capacity of the cooling system exceeds a battery heat generation amount of the battery unit, give an instruction to the cooling system for the second target temperature as the target battery temperature; and
when the normal traveling mode is executed in a state in which the heating in the vehicle cabin is requested and the battery cooling capacity is equal to or lower than the battery heat generation amount, give an instruction to the cooling system for the first target temperature as the target battery temperature.

When the control device is executing the normal traveling mode, the battery cooling capacity may become equal to or lower than the battery heat generation amount. When the instruction for the second target temperature as the target battery temperature is given in such a situation, the period in which the battery temperature exceeds the threshold temperature increases and the deterioration of the battery unit is likely to proceed. In the above configuration, when the normal traveling mode is executed in the state in which the heating in the vehicle cabin is requested and the battery cooling capacity exceeds the heat generation amount, the control device gives the instruction to the cooling system for the second target temperature as the target battery temperature. Therefore, it is possible to reduce the occurrence of the case where the battery temperature exceeds the threshold temperature, and it is possible to suppress the deterioration of the battery unit.

In a third aspect, in the second aspect, the electrified vehicle may further include a heat generation component. The control device may be configured to set the second target temperature to decrease as a heat generation amount of the heat generation component increases.

As the heat generation amount of the heat generation component increases, the battery cooling capacity decreases. In the above configuration, the control device sets the second target temperature to decrease as the heat generation amount of the heat generation component increases. Therefore, it is possible to reduce the occurrence of the case where the battery temperature exceeds the threshold temperature, and it is possible to suppress the deterioration of the battery unit.

In a fourth aspect, in any one of the first to third aspects, the electrified vehicle may further include an outside air temperature sensor configured to detect an outside air temperature. The control device may be configured to set the second target temperature to decrease as the outside air temperature increases.

As the outside air temperature increases, the cooling capacity of the cooling system decreases. In the above configuration, the control device sets the second target temperature to decrease as the outside air temperature increases. Therefore, it is possible to reduce the occurrence of the case where the battery temperature exceeds the threshold temperature, and it is possible to suppress the deterioration of the battery unit.

In a fifth aspect, the electrified vehicle may further include a driver's seat and a passenger's seat adjacent to the driver's seat in a lateral direction. The battery unit may be disposed between the driver's seat and the passenger's seat in the lateral direction. A front end of the battery unit may be located on a front side with respect to a front end of the driver's seat in a longitudinal direction, and a rear end of the battery unit may be located on a rear side with respect to a rear end of the driver's seat in the longitudinal direction.

In the above configuration, the exhaust heat of the battery unit is easily transferred to the vehicle cabin. Therefore, it is possible to reliably heat the vehicle cabin by utilizing the exhaust heat of the battery unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an electrified vehicle 2;

FIG. 2 is a view showing the arrangement of the battery unit 10 when electrified vehicle 2 is viewed from above;

FIG. 3 is a diagram showing the arrangement of the battery unit 10 when electrified vehicle 2 is viewed from the right side;

FIG. 4 is a graph showing the relationship between the degree of deterioration of the battery unit 10 and the battery temperature;

FIG. 5 is a flowchart of a target temperature setting process executed by the control device 30;

FIG. 6 is a graph illustrating a relationship between a battery cooling capacity and a second target temperature;

FIG. 7 is a graph showing the relation between the cooling capacity and the calorific value in electrified vehicle of the comparative embodiment; and

FIG. 8 is a diagram illustrating a relation between the cooling capacity and the calorific value in electrified vehicle 2.

### DETAILED DESCRIPTION OF EMBODIMENTS

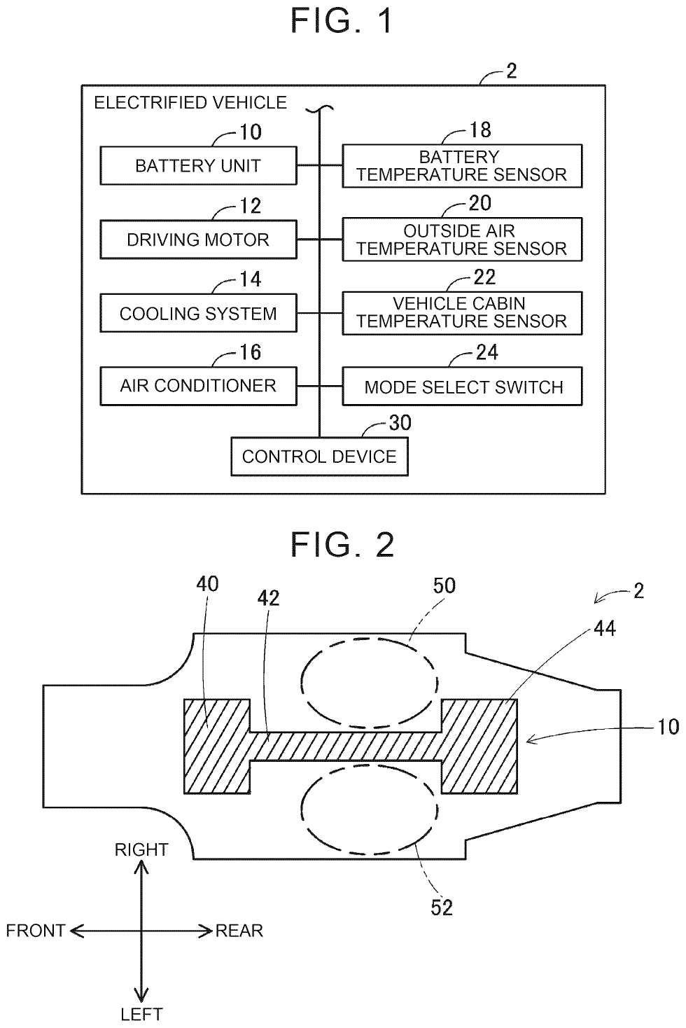

Referring to FIGS. 1 to 3, electrified vehicle 2 will be described. In one embodiment, electrified vehicle 2 is a battery electrified vehicle, a hybrid electrified vehicle, a fuel cell electrified vehicle, or a plug-in hybrid electrified vehicle. Electrified vehicle 2 includes a battery unit 10, a traveling motor 12, a cooling system 14, and an air conditioner 16. Electrified vehicle 2 further includes a battery temperature sensor 18, an outside air temperature sensor 20, a vehicle cabin temperature sensor 22, a mode selection switch 24, and a control device 30. The battery temperature sensor 18 detects a battery temperature which is a temperature of the battery unit 10. The outside air temperature sensor 20 detects the outside air temperature. The vehicle cabin temperature sensor 22 detects the vehicle cabin temperature, which is the temperature in the vehicle cabin of electrified vehicle 2.

The battery unit 10 is an electrified vehicle 2 power source and supplies electric power to the traveling motor 12. The battery unit 10 includes a plurality of battery cells. A battery cell is a rechargeable battery cell, e.g., a lithium-ion battery cell or a full-solid-state battery.

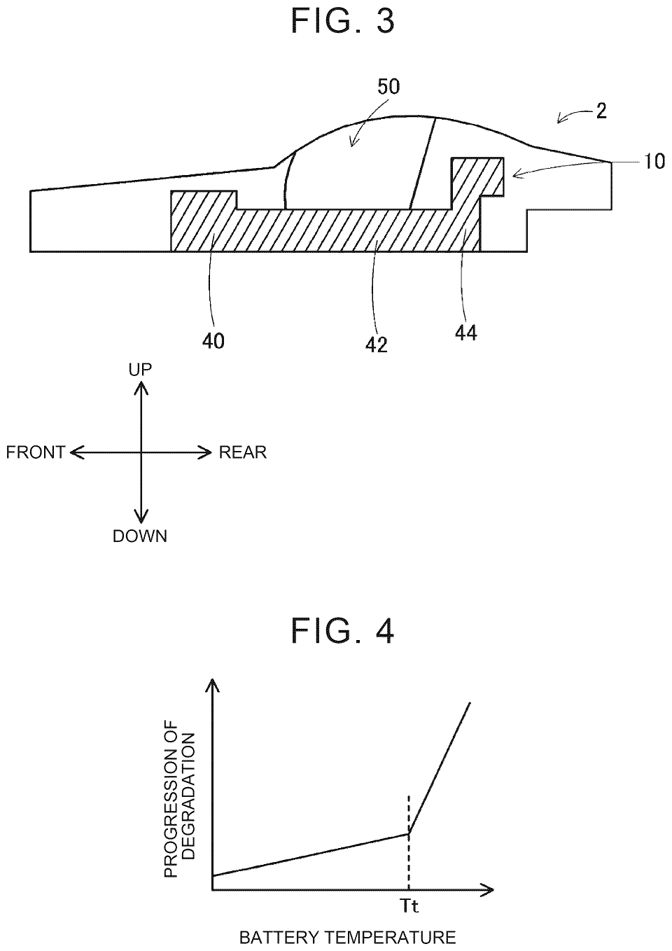

Referring to FIGS. 2 and 3, the arrangement of the battery unit 10 in electrified vehicle 2 will be described. In FIGS. 2 and 3, the battery unit 10 is hatched for ease of understanding.

As illustrated in FIG. 2, the battery unit 10 includes a front battery portion 40, a central battery portion 42, and a rear battery portion 44. The central battery portion 42 extends in the front-rear direction at a central portion in the left-right direction of electrified vehicle 2. The central battery portion 42 is provided between the driver's seat 50 and a passenger's seat 52 provided on the left side of the driver's seat 50. As shown in FIG. 3, the 30 upper end of the central battery portion 42 is positioned above a seat surface (not shown) of the driver's seat 50. As shown in FIG. 2, the front battery portion 40 extends forward from the front end of the central battery portion 42. The length of the front battery portion 40 in the left-right direction is longer than the length of the central battery portion 42 in the left-right direction. Therefore, a portion of the front battery portion 40 on the right side of the central battery portion 42 is located on the front side of the driver's seat 50, and a portion of the front battery portion 40 on the left side of the central battery portion 42 is located on the front side of the passenger's seat 52. As shown in FIG. 3, the upper end of the front battery portion 40 is located above the upper end of the central battery portion 42. As shown in FIG. 2, the rear battery portion 44 extends forward from the rear end of the central battery portion 42. The length of the rear battery portion 44 in the left-right direction is longer than the length of the central battery portion 42 in the left-right direction. Therefore, a portion of the rear battery portion 44 on the right side of the central battery portion 42 is located on the rear side of the driver's seat 50, and a portion of the rear battery portion 44 on the left side of the central battery portion 42 is located on the rear side of the passenger's seat 52. As shown in FIG. 3, the upper end of the rear battery portion 44 is located above the upper end of the front battery portion 40.

The traveling motor 12 of FIG. 1 is connected to the wheels of electrified vehicle 2, and is a traveling motor that drives the wheels.

The cooling system 14 is a system that uses a cooling medium or the like to cool the battery unit 10, the traveling motor 12, and the like. The cooling system 14 cools the battery unit 10 in accordance with a target battery temperature to be described later.

The air conditioner 16 is a so-called car air-conditioner. The air conditioner 16 performs air conditioning on the vehicle cabin in accordance with the setting performed by the user and/or the temperature in the vehicle cabin.

The control device 30 includes a CPU and memories such as a ROM and a RAM. The control device 30 instructs the cooling system 14 to set a target battery temperature for suppressing the deterioration of the battery unit 10 from being accelerated. The target battery temperature is the temperature at which the battery temperature should follow. As shown in FIG. 4, the degree of deterioration of the battery unit 10 rapidly increases when the degree of deterioration becomes higher than the threshold-temperature Tt. That is, when the battery temperature becomes higher than the threshold temperature Tt, degradation of the battery unit 10 is accelerated. Therefore, the control device 30 of FIG. 1 suppresses the battery temperature from becoming higher than the threshold temperature Tt by instructing the cooling system 14 to the target battery temperature. The target battery temperature is a temperature equal to or lower than the threshold temperature Tt. In the memory of the control device 30, a first target temperature for use as a target battery temperature is stored in advance. As an example, the first target temperature is 30° C.

The control device 30 is configured to be able to selectively execute a plurality of driving modes including a normal driving mode and a circuit driving mode. The normal traveling mode is a mode used when traveling on a so-called public road. The circuit running mode is a mode used for running on a circuit, and is a running mode capable of achieving running with a higher running load than when the normal running mode is executed. By operating the mode selection switch 24, the user can select which of the normal traveling mode and the circuit traveling mode is to be executed by the control device 30. As an example, in the circuit running mode, the upper limit speed is increased. In the modified example, the plurality of driving modes may include an eco-driving mode, a sports driving mode, and the like.

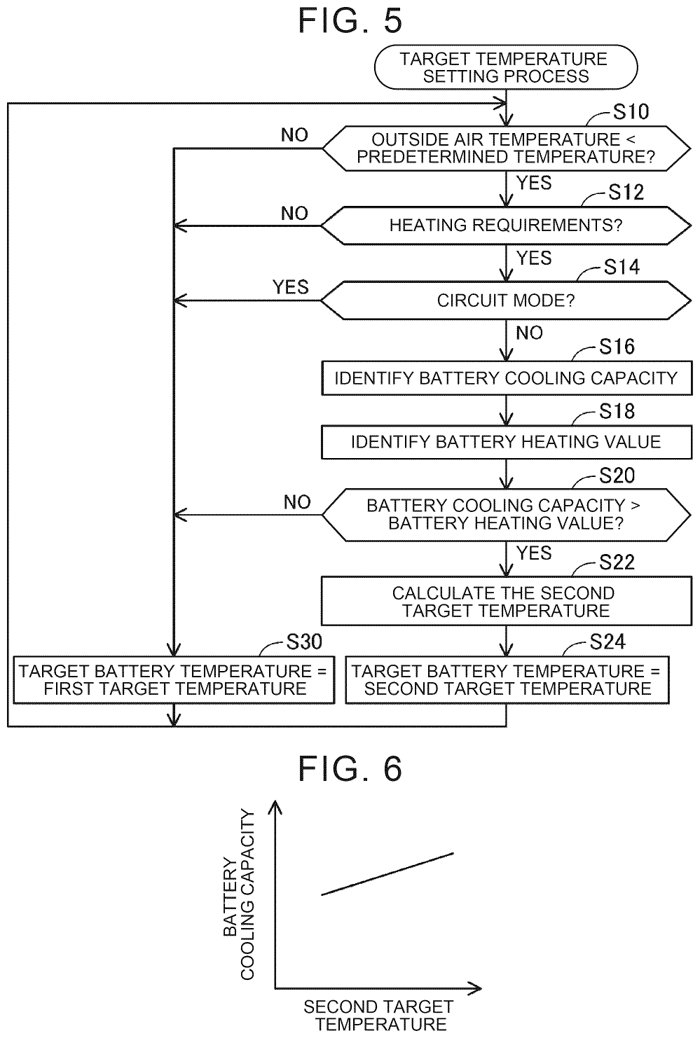

### Target Temperature Setting Process; FIG. 5

Referring to FIG. 5, a target-temperature setting process executed by the control device 30 of electrified vehicle 2 will be described. The target temperature setting process is a process for setting the target battery temperature. The control device 30 instructs the cooling system 14 to the target battery temperature set in the target temperature setting process.

In S10, the control device 30 determines whether or not the outside air temperature is lower than a predetermined temperature. As an example, the predetermined temperature is 10° C. The control device 30, when the outside air temperature is less than the predetermined temperature (YES at S10), the process proceeds to S12, when the outside air temperature is equal to or higher than the predetermined temperature (NO at S10), the process proceeds to S30.

In S12, the control device 30 determines whether or not heating of the vehicle cabin is required. The control device 30 proceeds to S14 when the heating in the vehicle cabin is required (YES in S12), and proceeds to S30 when the heating in the vehicle cabin is not required (NO in S12).

In S14, the control device 30 determines whether or not the circuit running mode is selected. When the circuit running mode is selected (YES in S14), the control device 30 proceeds to S30, and when the circuit running mode is not selected (NO in S14), it proceeds to S16.

In S16, the control device 30 specifies the battery cooling capacity of the cooling system 14 by using the outside air temperature and the calorific value of the traveling motor 12 or the like. The battery cooling capacity is a cooling capacity available for cooling the battery unit 10 among the cooling capacities of the cooling system 14. The control device 30 utilizes the outside air temperature to determine the cooling capacity of the cooling system 14. The cooling capacity of the cooling system 14 increases as the outside air temperature decreases. The control device 30 specifies the cooling capacity necessary for cooling the traveling motor 12 and the like from the calorific value of the traveling motor 12 and the like, and specifies the battery cooling capacity by subtracting the cooling capacity necessary for cooling the traveling motor 12 and the like from the cooling capacity of the cooling system 14.

In S18, the control device 30 specifies a battery heating value which is a heating value of the battery unit 10. Specifically, the control device 30 specifies the battery heating value by using the value of the current flowing through the battery unit 10 and the value of the internal resistance of the battery unit 10.

In S20, the control device 30 determines whether or not the battery cooling capacity specified by S16 exceeds the battery heating value specified by S18. The control device 30 goes to S22 if the battery cooling capacity is above the battery heating value (YES in S20) and if the battery cooling capacity is below the battery heating value (NO in S20), then goes to S30.

In S22, the control device 30 calculates the second target temperature by using the battery-cooling capacity specified by S16. The second target temperature is higher than the first target temperature. As illustrated in FIG. 6, the control device 30 sets the second target temperature to be higher as the battery cooling capacity is higher. In other words, the control device 30 sets the second target temperature lower as the outside air temperature is higher, and sets the second target temperature lower as the amount of heat generated by the traveling motor 12 or the like is larger. In the present embodiment, the maximum value of the second target temperature is the same as the threshold temperature Tt.

In S24 of FIG. 5, the control device 30 sets the second target temperature calculated by S22 as the target battery temperature. When S24 ends, the control device 30 returns to S10.

In addition, when it is determined that S10, S12, S14, S16 or S20 is NO, in S30, the control device 30 sets the first target temperature as the target battery temperature. When S30 ends, the control device 30 returns to S10.

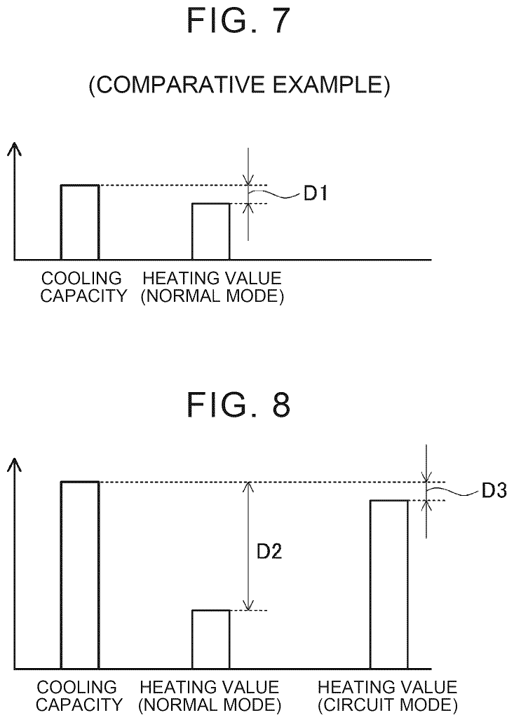

Referring to FIGS. 7 and 8, the reason why the target battery temperature can be set to a second target temperature higher than the first target temperature will be described. It should be noted that generally, the maximum cooling capacity of the cooling system 14 is designed based on the maximum heating value of electrified vehicle.

Referring to FIG. 7, the maximum-cooling capacity in electrified vehicle of the comparative embodiment will be described. In electrified vehicle of the comparative embodiment, the control device can execute the normal running mode. Electrified vehicle of the comparative example has the same configuration as electrified vehicle 2 of the present embodiment, except that the circuit running mode cannot be executed. In electrified vehicle of the comparative example, the maximum calorific value in the normal running mode is the maximum calorific value of electrified vehicle of the comparative example. The maximum cooling capacity is designed to be larger by a margin amount D1 than the maximum calorific value in the normal running mode.

Referring to FIG. 8, the maximum cooling capacity of the cooling system 14 in electrified vehicle 2 of the present embodiment will be described. In electrified vehicle 2, the maximum calorific value in the circuit running mode is the maximum calorific value of electrified vehicle 2. The maximum cooling capacity of the cooling system 14 is designed to be larger by a margin amount D3 than the maximum heating value in the circuit running mode. The margin amount D3 is substantially the same as the margin amount D1. Since the maximum cooling capacity of the cooling system 14 is designed based on the maximum calorific value in the circuit running mode, the maximum calorific value in the normal running mode is relatively smaller than the maximum cooling capacity of the cooling system 14. In the present embodiment, the maximum heat generation amount in the normal running mode is smaller than the maximum cooling capacity of the cooling system 14 by the difference amount D2. Therefore, the difference between the maximum heat generation value of electrified vehicle 2 and the maximum cooling capacity of the cooling system 14 is relatively large. Therefore, even if the target battery temperature is set to the second target temperature higher than the first target temperature, the battery unit 10 can be sufficiently cooled, and the battery temperature can be suppressed from exceeding the threshold temperature Tt. For this purpose, the target battery temperature can be set to a second target temperature higher than the first target temperature.

As described above, electrified vehicle 2 includes the battery unit 10, the cooling system 14 that cools the battery unit 10 in accordance with the designated target battery temperature, the air conditioner 16 that controls the temperature in the vehicle cabin, and the control device 30 that can selectively execute the plurality of driving modes. The plurality of traveling modes includes a normal traveling mode and a circuit traveling mode (an example of the “high-load traveling mode”) capable of realizing a traveling with a higher traveling load than when the normal traveling mode is executed. The control device 30 instructs the cooling system 14 to set the first target temperature as the target battery temperature (S30) when the circuit running mode is executed (YES in S14) in a state where the heating in the vehicle cabin is required (YES in S12 of FIG. 5). The control device 30 instructs the cooling system 14 to set a second target temperature higher than the first target temperature as a target battery temperature (S24) when the normal traveling mode is executed (NO in S14) in a state where heating in the vehicle cabin is required.

According to the above configuration, the control device 30 instructs the cooling system 14 to set the second target temperature as the target battery temperature when the normal traveling mode is executed in a state in which the vehicle cabin is required to be heated. As shown in FIG. 8, since the maximum cooling capacity is designed based on the maximum heat generation amount in the circuit running mode, there is a sufficient margin between the maximum heat generation amount in the normal running mode and the maximum cooling capacity. Therefore, even if the target battery temperature is set to the second target temperature, it is possible to suppress the battery temperature from becoming higher than the threshold temperature Tt. Further, when the target battery temperature is set to the second target temperature, the vehicle cabin is easily warmed by the exhaust heat of the battery unit 10. Therefore, it is possible to effectively use the exhaust heat of the battery unit 10 while suppressing the deterioration of the battery unit 10 from being accelerated.

In addition, the control device 30 instructs the cooling system 14 to set the second target temperature as the target battery temperature when the normal running mode is executed (NO in S14) in a state where heating in the vehicle cabin is required (YES in S12) and the battery cooling capacity available for cooling the battery unit 10 among the cooling capacities of the cooling system 14 exceeds the battery heating capacity of the battery unit 10 (YES in S20). The control device 30 instructs the cooling system 14 to set the first target temperature as the target battery temperature when the normal running mode is being executed (NO in S20) in a state where the heating in the vehicle cabin is required (YES in S12) and the battery cooling capacity is equal to or lower than the battery heating value (S30).

In a case where the control device 30 is executing the normal running mode, a situation may occur in which the battery cooling capacity becomes equal to or lower than the battery heating value. In such a situation, when the target battery temperature is set to the second target temperature, the time for the battery temperature to exceed the threshold temperature Tt becomes longer, and degradation of the battery unit 10 is likely to proceed. According to the above configuration, the control device 30 instructs the cooling system 14 to set the second target temperature as the target battery temperature when the normal running mode is executed in a state where the heating in the vehicle cabin is required and the battery cooling capacity exceeds the amount of heat generation. Therefore, it is possible to suppress the battery temperature from exceeding the threshold temperature Tt, and it is possible to suppress degradation of the battery unit 10.

Electrified vehicle 2 further includes a traveling motor 12 (an exemplary “heat generation component”). The control device 30 sets the second target temperature lower as the amount of heat generated by the traveling motor 12 increases.

The larger the amount of heat generated by the traveling motor 12, the lower the battery cooling capacity. According to the above configuration, the control device 30 sets the second target temperature lower as the amount of heat generated by the traveling motor 12 increases. Therefore, it is possible to suppress the battery temperature from exceeding the threshold temperature Tt, and it is possible to suppress degradation of the battery unit 10.

Electrified vehicle 2 further includes an outside air temperature sensor 20 that detects the outside air temperature. The control device 30 sets the second target temperature to be lower as the outside air temperature is higher.

The higher the outside air temperature, the lower the cooling capacity of the cooling system 14. According to the above configuration, the control device 30 sets the second target temperature to be lower as the outside air temperature is higher. Therefore, it is possible to suppress the battery temperature from exceeding the threshold temperature Tt, and it is possible to suppress degradation of the battery unit 10.

Electrified vehicle 2 further includes a driver's seat 50 and a passenger's seat 52 adjacent to the driver's seat 50 in the left-right direction. The battery unit 10 is disposed between the driver's seat 50 and the passenger's seat 52 in the left-right direction. In the front-rear direction of the battery unit 10, the front end of the battery unit 10 is located on the front side relative to the front end of the driver's seat 50, and the rear end of the battery unit 10 is located on the rear side relative to the rear end of the driver's seat 50.

According to the above configuration, the exhaust heat of the battery unit 10 is easily transmitted to the vehicle cabin. Therefore, it is possible to firmly heat the vehicle cabin by utilizing the exhaust heat of the battery unit 10.

Although the specific examples of the present disclosure have been described in detail above, these are merely examples and do not limit the scope of claims. The techniques described in the claims include various modifications and alternations of the specific examples illustrated above.

### First Modification

The control device 30 may execute any one of the normal traveling mode and the circuit traveling mode by using the position data of electrified vehicle 2. In the present modification, electrified vehicle 2 may not include the mode selection switch 24. Electrified vehicle 2 may include a device for detecting the position of electrified vehicle 2, for example, a GPS. In the present modification, the control device 30 determines whether or not electrified vehicle 2 is located in the circuit in S14.

### Second Modification

S20 of FIG. 5 can be omitted.

### Third Modification

The second target temperature may be the same regardless of the magnitude of the outside air temperature and the amount of heat generated by the traveling motor 12 or the like. In this modification, S22 of FIG. 5 can be omitted.

### Fourth Modification

In the up-down direction, the battery unit 10 may be disposed below the driver's seat 50 and the passenger's seat 52.

### Fifth Modification

The “high-load running mode” is not limited to the circuit running mode, and may be a sports running mode or the like.

The technical elements described in this specification or in the drawings exhibit technical utility alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. An electrified vehicle comprising:
a battery unit;
a cooling system configured to cool the battery unit based on a target battery temperature under instruction;
an air conditioner configured to control a temperature in a vehicle cabin; and
a control device configured to selectively execute a plurality of traveling modes including a normal traveling mode and a high load traveling mode expected to perform traveling with a traveling load higher than a traveling load in the normal traveling mode, wherein the control device is configured to:
when the high load traveling mode is executed in a state in which heating in the vehicle cabin is requested, give an instruction to the cooling system for a first target temperature as the target battery temperature; and
when the normal traveling mode is executed in the state in which the heating in the vehicle cabin is requested, give an instruction to the cooling system for a second target temperature higher than the first target temperature as the target battery temperature.

2. The electrified vehicle according to claim 1, wherein the control device is configured to:
when the normal traveling mode is executed in a state in which the heating in the vehicle cabin is requested and a battery cooling capacity available for cooling the battery unit in a cooling capacity of the cooling system exceeds a battery heat generation amount of the battery unit, give an instruction to the cooling system for the second target temperature as the target battery temperature; and
when the normal traveling mode is executed in a state in which the heating in the vehicle cabin is requested and the battery cooling capacity is equal to or lower than the battery heat generation amount, give an instruction to the cooling system for the first target temperature as the target battery temperature.

3. The electrified vehicle according to claim 2, further comprising a heat generation component, wherein the control device is configured to set the second target temperature to decrease as a heat generation amount of the heat generation component increases.

4. The electrified vehicle according to claim 2, further comprising an outside air temperature sensor configured to detect an outside air temperature, wherein the control device is configured to set the second target temperature to decrease as the outside air temperature increases.

5. The electrified vehicle according to claim 1, further comprising:
a driver's seat; and
a passenger's seat adjacent to the driver's seat in a lateral direction, wherein:
the battery unit is disposed between the driver's seat and the passenger's seat in the lateral direction; and
a front end of the battery unit is located on a front side with respect to a front end of the driver's seat in a longitudinal direction, and a rear end of the battery unit is located on a rear side with respect to a rear end of the driver's seat in the longitudinal direction.
